(19) United States
(12) Patent Application Publication
(10) Pub. No.: US 2022/0324166 A1
(43) Pub. Date: Oct. 13, 2022

(54) A COOLED EXTRUDER, FIXABLE TO A PRINTING CARRIAGE OF A MACHINE FOR QUICK PROTOTYPING WITH THREAD OF FILLER MATERIAL

(71) Applicant: ROBOZE S.P.A., Bari (BA) (IT)

(72) Inventor: Alessio LORUSSO, Bari (BA) (IT)

(21) Appl. No.: 17/620,992

(22) PCT Filed: Jun. 19, 2020
(86) PCT No.: PCT/IB2020/055792

§ 371 Date: Dec. 20, 2021

(30) Foreign Application Priority Data
Jun. 21, 2019 (IT) 102019000009828

(51) Int. Cl. B29C 64/209; B29C 64/295; B33Y 30/00

(52) U.S. Cl. CPC B29C 64/209; B29C 64/295; B33Y 30/00

(57) ABSTRACT

Disclosed is an extrusion system including a cooled extruder, fixable to a pressing carriage of a machine for quick prototyping with thread of filler material, including: a unit for controlled and localized heating of the filler material, a unit blowing compressed air onto a zone of the extruder to be cooled, immediately upstream of the melting zone, with a predetermined flow rate, a channel supplying the thread of filler material. The extruder includes a nozzle whose body includes a melting zone, and with an outlet end conveying the material on a pressing plane. The nozzle is integral with a heating block. The nozzle is made of a material having high wear and corrosion resistance and good workability. At least at the melting zone of the nozzle is internally processed with a surface finishing having a roughness 0.2-2.5 pm or less, which ensures a good flowabitly of the material.

### CROSS-REFERENCE TO RELATED APPLICATIONS

This application is the U.S. national phase of International Application No. PCT/IB2020/055792 filed Jun. 19, 2020 which designated the U.S. and claims priority to IT Patent Application No. 102019000009828 filed Jun. 21, 2019, the entire contents of each of which are hereby incorporated by reference.

### BACKGROUND OF THE INVENTION

### Field of the Invention

The present invention relates to the sector of machines for quick prototyping, commonly referred to as “3D printers”.

More specifically, it relates to a cooled extruder, particularly adapted for 3D printing using materials with a high melting point.

### Description of the Related Art

Used inside additive production systems, the extruder is the machine element intended to create the change of state of the thread from solid to viscoelastic, allowing the material to be deposited in layers.

During the extrusion process, the material is carried inside the extruder by a drive system, the temperature reached in the extruder allows the change of state of the material, which will be deposited layer by layer on the printing plane.

One currently known problem of 3D printers regards the maximum working temperature for the extruder, and this results in the drawback, that at present, materials with a relatively low melting point are used: both for problems of cooling the extruder and for problems of collecting the pressed piece.

### SUMMARY OF THE INVENTION

It is the main object of the extruder, the subject of the present invention, to allow 3D printing using both technical polymers with high melting points (peek) and technical polymers loaded with carbon or glass balls with a high-temperature matrix.

This and other objects will be better understood from the following description and with reference to the attached figures, which show, by way of an illustrative and non-limiting example, preferred embodiments of the invention, with some variations.

### BRIEF DESCRIPTION OF THE DRAWINGS

In the drawings:

FIG. 1 is a longitudinal section of a first embodiment of the extruder according to the present invention;

FIGS. 1A and 1B show two relative enlarged details indicated with the letters “E”, “F” in FIG. 1, respectively:

“E” for the packing of the components for the seal of leakages of the molten material,

“F” for the zone with small outer transversal dimensions with the flow of cooling air;

FIG. 2 is an exploded view of the extruder corresponding to the section in FIG. 1;

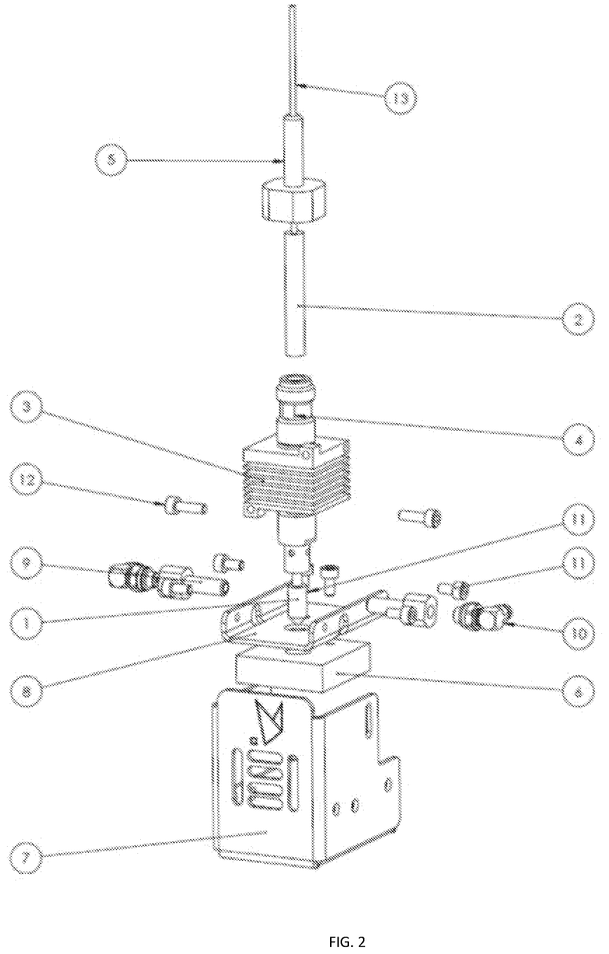

FIG. 3 is a section similar to the one in FIG. 1, which shows a first variation of the invention, wherein the small conveyor tube made of a ceramic material is absent;

FIG. 4 is a section similar to the one in FIG. 1, which shows a second variation of the invention, wherein both the small conveyor tube made of a ceramic material and the outer straw are absent;

FIG. 5 is a section similar to the one in FIG. 1, which shows a second embodiment of the invention, wherein the nozzle of the extruder is directly removable from the bottom without needing to dismantle other components of the extruder;

FIG. 6 shows an enlarged detail indicated with letter “G” in FIG. 1 relating to the interior of the end part of the nozzle;

FIGS. 7, 8 and 9 show variations of the detail G in FIG. 6, indicated with letter G′, G″ and G′″ respectively;

FIG. 10 is a 3d view of a third embodiment of the invention, wherein only one cooling air conveyor is included;

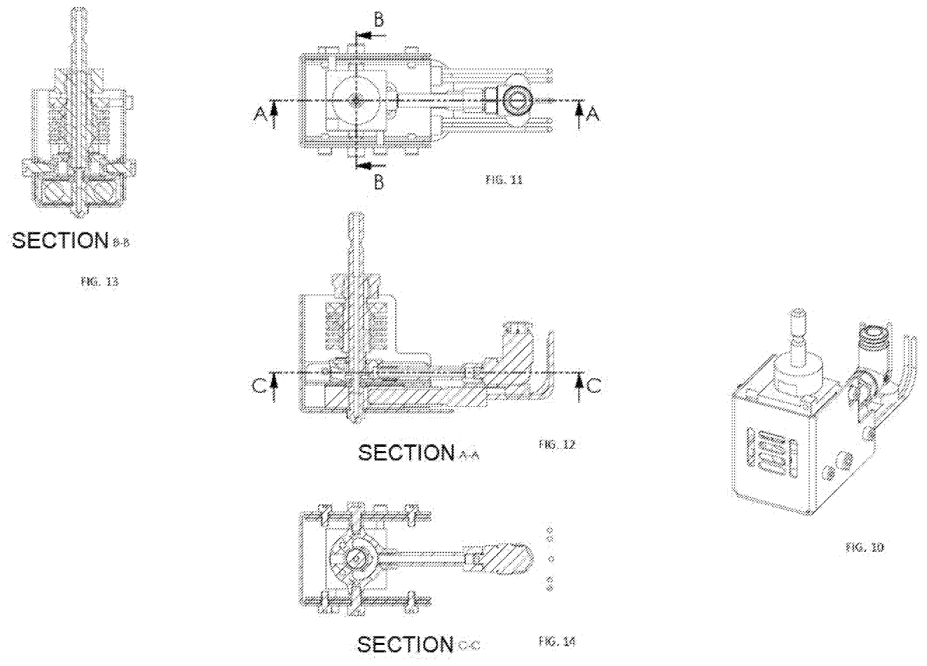

figures from 11 to 14, corresponding to FIG. 10, show, respectively: a plan view and a longitudinal sectional view according to a trace plane A-A in FIG. 11, a transversal sectional view according to a trace plane B-B in FIG. 11, and a longitudinal sectional view according to a trace plane C-C in FIG. 12.

### DESCRIPTION OF THE PREFERRED EMBODIMENTS

With reference to the figures indicated above, the extruder, the subject of the present invention, is provided with a body assembled integrally to the printing carriage, substantially formed by a plurality of components assembled rigidly to one another.

According to the present invention, the extrusion is guaranteed by the combination of:
means for controlled and localized heating,
means for blowing air at a low temperature and predetermined flow rate, determined on the basis of experimental tests,
a channel (or conduit) for supplying the thread of melting material, conveniently configured to improve the flowability;

The various components, which contribute to forming the body of the extruder, will be examined below in detail.

Nozzle 1: it is a substantially cylindrical element in which the melting of the material and the conveying of the material on the printing plane take place. Such nozzle 1 is integral with the heating block 6, preferably by means of a thread.

In the described embodiment, the material of the nozzle 1 is stainless steel, such as, for example, Aisi 303, which has high wear resistance, corrosion resistance and good workability. At the melting zone, the conduit in which the thread 13 of filler material slides is processed internally with a surface finishing from 0.2 to 2.5 μm, which ensures a good flowability of the material, reducing surface adhesion and risks of vulcanization of the material. The melting zone is preferably an integral part of the nozzle, to avoid leakages of molten material between the joints.

It is worth noting that, according to the present invention, the nozzle 1 can be made not only of stainless steel, but also of other materials adapted for the purpose, such as, for example, tungsten carbide.

According to a particular feature of the invention, before the melting zone (which is the section of the nozzle 1 in which the melting of the thread of filler material 13 takes place) the body of the nozzle 1 has a zone in which the outer transversal dimensions thereof are smaller, and external air is conveyed onto such a zone. In this way, the limited mass of material, which conducts heat present in such a zone with small outer dimensions, combined with the cooling air hitting it from the outside, is adapted to lower the temperature of the nozzle 1 drastically in the section of transition from the zone of melting to that of loading the filler material, thus ensuring a thermal equilibrium to avoid the thread from dilating due to the increase in temperature, causing the melting and therefore the extrusion to be interrupted.

Small tube 2: the component of the extruder, which acts as a conveyor for the thread and preferably is made of Alumina. This material has a good thermal stability, excellent hardness, excellent wear resistance, good thermal insulation.

The good thermal insulation, which characterizes the small tube 2 made of alumina, has been specifically comprised for the purpose of ensuring a correct equilibrium between the heat it receives from the nozzle 1—with which it is in direct contact—and the heat dissipated towards the external environment. Basically, the small tube 2 acts as a thermal buffer, proving indispensable in this application, where the working temperatures exceed 400° C., to avoid the thread 13 from dilating in the loading zone with the consequent undesired blocking of the thread.

Heat sink made of aluminum 3: the high thermal conductivity of the aluminum allows the heat sink 3 to remove the heat from the surface of the outer straw 4 more effectively and disperse it towards the surrounding environment by means of special dissipation flaps, thus allowing an adequate thermal equilibrium to be achieved and maintained. The shape and processings of this component have been studied with the aim of increasing the thermal exchange surface in a reduced space. Furthermore, the heat sink 3 is also screwed onto the corresponding zone of the nozzle 1, which is situated therein.

Outer straw 4: this component holds the small ceramic tube 2 internally for the thread 13 to flow, while externally it is screwed to the heat sink 3. The material of such a straw 4 is preferably Aisi 303, The high thermal conductivity of this material, with respect to Alumina, allows and favors the transfer of heat from the inner small tube 2 to the outer heat sink 3.

Extruder connection 5: allows the extrusion assembly to be rigidly constrained to the printing carriage and it is screwed to the outer straw 4. Such connection 5 of the extruder has an inner ledge, which ensures the packing of the small ceramic tube 2 against the nozzle 1, preventing the molten material from exiting the connection orifices.

Heating block 6: this component comprises heating elements, a temperature detection sensor and a block made of Steel, which contains said heating elements and onto which the nozzle 1 is screwed 1, to which the heat produced by said heating elements is transferred by conduction. Externally, such heating block 6 is protected by a layer of insulating material, such as, for example, “Areogel”, to limit the dissipation of heat externally, thus improving the efficiency of the heating block. It is interesting to note that the presence of this insulation is also important to avoid, or at least reduce the undesired heating of the material newly pressed by the extruder.

The length of the heating block 6 can vary preferably, but not exclusively, from 8 to 30 mm. The shape thereof is not important, it can be cylindrical or parallelepiped or polygonal or polyhedral.

Cover made of steel 7: together with the protective/cover plate 8 it keeps the extruder fixed, allows the connection of the air conveyors and acts as a container for the insulating material (such as, as a non-limiting example Aereogel). Furthermore, it facilitates and favors the protection of the piece, which has just been pressed or is being pressed, from the high temperatures generated by the heating block 6.

Cooling air conveyors 9: each of these directs and channels the compressed air flow directly into the outer transversal constriction zone of the nozzle 1. According to a particular feature of the invention—in order to interrupt the transition of heat from the melting zone to the loading zone of the thread 13—preferably, the cooling air is conveyed into the section straddling the end of the loading zone and the beginning of the zone with small outer transversal dimensions.

Connections 10: the elements for connecting said conveyors 9 to the tubes, which supply the compressed air.

Screws 11-12: screws for the mutual fastening of the various parts.

Thread 13: thread of filler material

Compressed air 14: the pressure of the compressed air is at 2-10 bar, with a flow rate from 5 to 40 l/min.

### Conclusions:

The geometry of the nozzle, combined with the flow of cooling air and the small tube 2 made of alumina, allows the extruder to work at high temperatures, in excess of 400° C., ensuring the extrusion of the material, thus avoiding occlusions of the supply channel.

As is shown clearly in the drawings, according to the present invention, the components of the extruder are included to define, as a whole thereof, a channel or conduit for the thread 13 of filler material to pass, crossing it from the inlet to the outlet.

The materials used have also been selected, besides from a thermal point of view, to extend the duration of the extruder over time, also with the use of loaded materials.

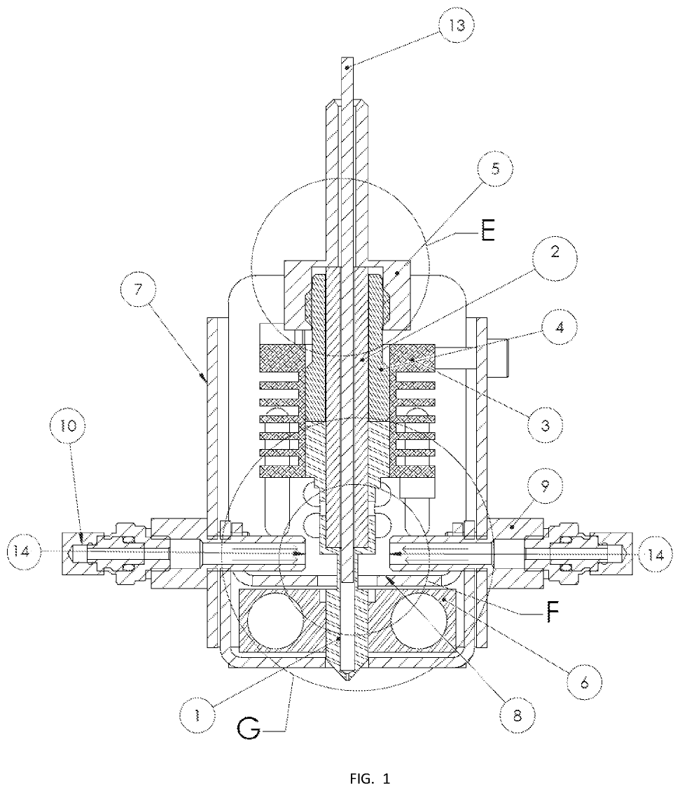

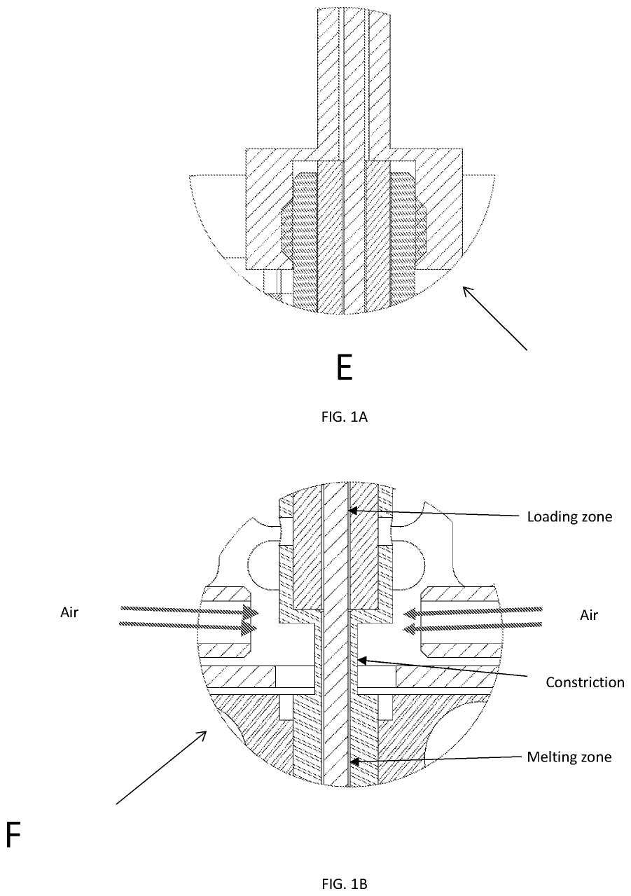

It is also worth noting that, as is clearly shown in FIG. 1, the nozzle 1, the small tube 2 made of alumina, the heat sink 3, the outer straw 4 and the connection 5 of the extruder, are all assembled and compacted coaxially with one another, so that the thread of filler material 13 can pass therein without undesired jamming or deviations: from the inlet in a solid state to the outlet hole of the nozzle 1, from which it exits in a viscoelastic or fluid state.

Furthermore, the proximal part of the nozzle and the distal part of the outer straw 4, which are adjacent to each other, are screwed to the heat sink, so that when the connection 5 of the extruder is screwed and tightened to the proximal part of the straw 4, the small tube 2 is axially pressed between the ledge of the straw 4 at one end thereof and the ledge present in the nozzle 1 at the opposite end thereof, thus avoiding potential leakages or spillages of the molten material inside the extruder.

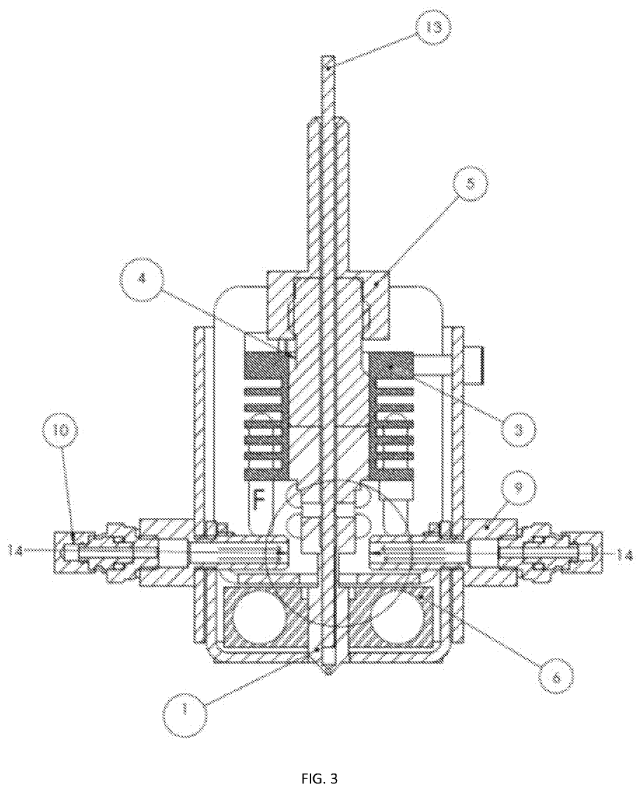

In the first variation of the invention shown in FIG. 3, the small tube 2 made of a ceramic material is absent and the thread slides directly into the outer straw 4 and into the nozzle 1.

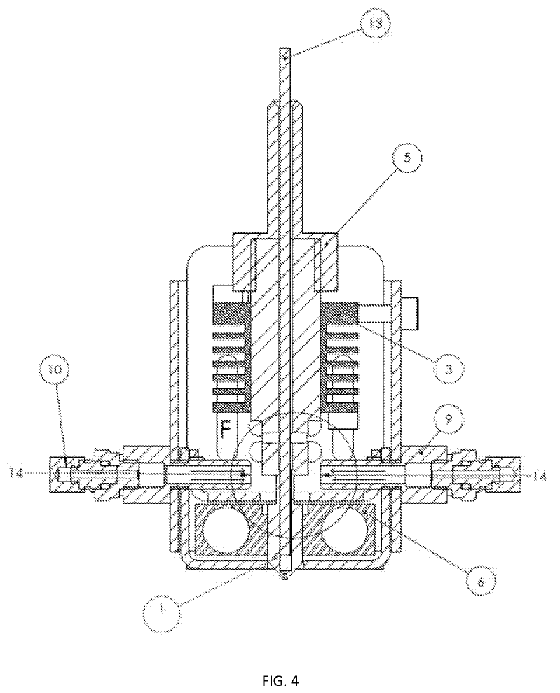

The second variation of the invention, shown in FIG. 4, is even simpler than the previous one because it is also devoid of the outer straw and the body of the nozzle 1 covers the entire extruder and is screwed directly to the upper connection 5.

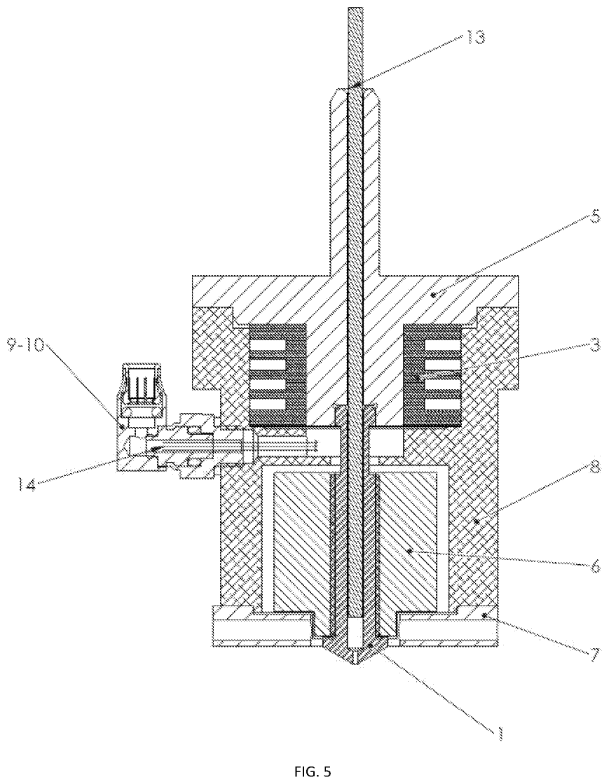

A second embodiment of the invention, shown in FIG. 5, includes a configuration of the nozzle, which makes it removable directly from the bottom without needing to dismantle any other component of the extruder. For such a purpose, the proximal part of the nozzle is fastened directly to the base of the connection 5, which also includes the heat sink 3.

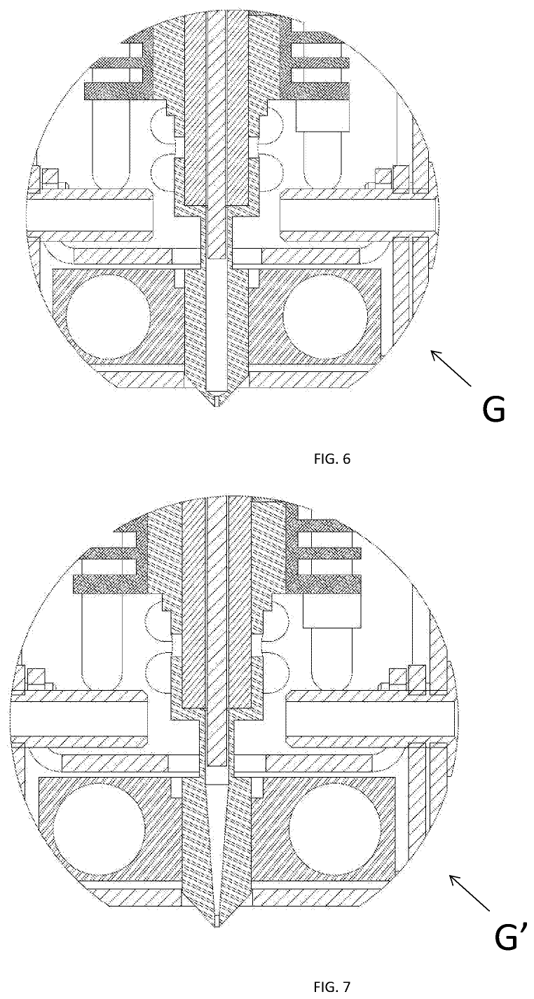

Finally, with reference to FIGS. 6, 7 and 8, it is interesting to note that the inner conformation of the end section of the nozzle 1 can have different configurations and geometries, which may be useful particularly for extruding high-viscosity polymers.

The detail G in FIG. 1 is shown in FIG. 6, in which it is possible to see that the inner conduit of the end part of the nozzle is cylindrical like the previous section of the conduit.

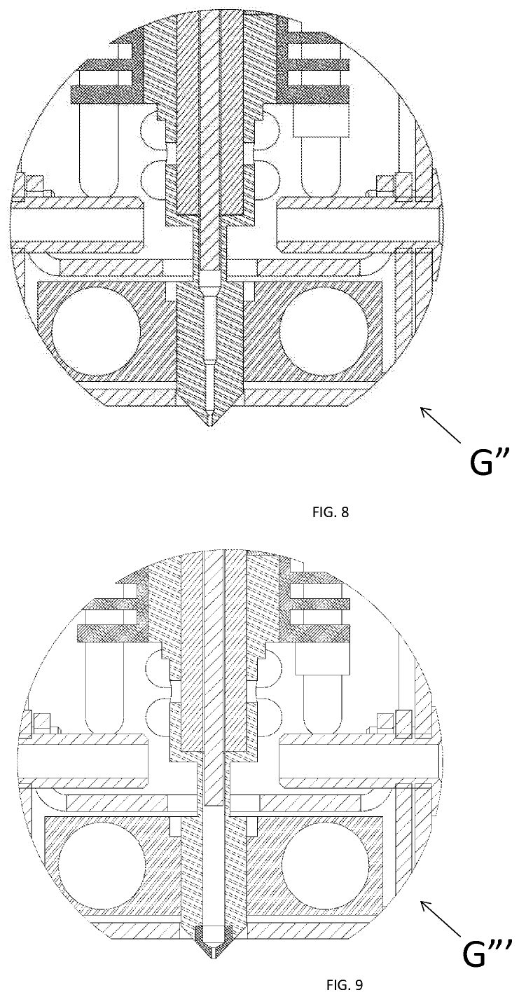

A first variation, indicated with G′ in FIG. 7, comprises that said end section, before the outlet hole of the filler material, is substantially conical.

A second variation, indicated with G″ in FIG. 8, comprises that said end section, before the outlet hole of the filler material, is provided with at least three different diameters, decreasing gradually towards the outlet.

Clearly, the number of inner diameters and the diameter of the thread used could also be different depending on the needs.

In a non-limiting embodiment, the inner diameters for the nozzle of the extrusion head can be divided in this manner:
diameter 2 mm
diameter 1.2 mm
diameter 0.8 mm
diameter 0.4 mm (towards the outlet)

The diameter of 2 mm accommodates the filament (which can have a diameter of 1.75 mm) and it starts to melt it so that the filament continues to slide, passing through the various diameters, always reducing the viscosity thereof and increasing the flow velocity until it exits the last diameter of 0.4 mm.

According to the present invention, the measurement of the diameters inside the nozzle of the extrusion head preferably has the following reference ranges:
initial inlet diameter equal to 2.5 mm±1
first intermediate diameter 1.2 mm±0.3
second intermediate diameter 0.8 mm±0.35
outlet end diameter 0.4 mm±0.35.

Finally, with particular reference to a third variation, indicated with G′″ in FIG. 9, it is worth noting that for the purpose of increasing wear resistance and to improve the flowability of the filler material, at least the end part of the inner conduit of the nozzle could also be provided with an insert made of ruby or tungsten carbide (or another material adapted for the purpose), or with an opportune surface treatment, such as, for example, nitriding or nickel-plating.

With reference to the figures from 10 to 14, a third embodiment of the invention includes only one conveyor 9 for supplying the cooling air, which is intended to direct and channel the compressed air flow directly to the outer transversal constriction zone of the nozzle 1, wherein a channeling is also included, configured to channel the cooling air all around said outer transversal constriction zone of the nozzle (1) and to let out said air from the side opposite to the conveyor 9.

### KEY

1 Nozzle
2 Small tube conveyor thread
3 Aluminum heat sink
4 Outer straw
5 Extruder connection
6 Heating block
7 Cover
8 Cover plate
9 Air conveyor
10 L-connection-M5-Pipe 6
11 ISO 4762 M3×6-6N
12 ISO 4762 M3×10-10N
13 Thread of filler material
14 Compressed air (for example at 2-10 bar and 5-40 l/min)

1. An extrusion system comprising a cooled extruder, fixable to a printing carriage of a machine for quick prototyping with thread of filler material, comprising:
means for the controlled and localized heating of the thread of filler material (13),
means for blowing compressed air onto a zone of the extruder to be cooled, placed immediately upstream of the melting zone, with a predetermined flow rate determinable on the basis of experimental tests,
a channel, or conduit, for supplying the thread of filler material, conveniently configured to improve the flowability of the thread of filler material therein;
wherein said extruder includes a nozzle, the body of which is provided with a melting zone in which the melting of the thread of filler material takes place, and with an outlet end for conveying the material on a printing plane; said nozzle being integral with a heating block;
wherein said nozzle is made of a material having high wear resistance, corrosion resistance and good workability;
and wherein, at least at the melting zone of said nozzle, the conduit inside which the thread of filler material slides, is processed internally with a surface finishing having a roughness from 0.2 to 2.5 μm or less, which ensures a good flowability of the material, reducing or preventing surface adhesion and risks of vulcanization of the material; wherein the localized flow of cooling air_{y} allows the extruder to work at high temperatures, higher that 400° C., ensuring the extrusion of the material, preventing blocking of the supply channel; wherein the pressure of the compressed air is from 2 to 10 bar, with a flow rate from 5 at 40 l/min.

2. The extrusion system according to claim 1, wherein, before the melting zone, the body of the nozzle has a zone having smaller outer transversal dimensions than the rest of the nozzle, and wherein said blowing means convey the compressed air onto such a zone; thus obtaining that the limited mass of material of the nozzle body which conducts heat present in such a zone with small outer dimensions, combined with the cooling air hitting said zone from the outside, are adapted to lower the temperature of the nozzle drastically in the section of transition from the zone of loading the thread of filler material to that of melting the filler material, thus ensuring a thermal equilibrium to avoid the thread from dilating due to the increase in temperature, thus causing the melting and therefore the extrusion to be interrupted.

3. The extrusion system according to claim 1, wherein said extruder comprises a small ceramic tube which acts as a conveyor for the thread of filler material; the thermal insulation given by the small ceramic tube being provided in order to ensure a correct equilibrium between the heat that the small ceramic tube receives from the nozzle—with which the small ceramic tube is in direct contact—and the heat dissipated towards the external environment, thus obtaining that the small ceramic tube acts as a thermal buffer to avoid the thread of filler material from dilating in a loading zone, with the consequent undesired blocking of the thread itself.

4. The extrusion system according to claim 3, wherein said extruder comprises a heat sink made of high thermal conductivity material for removing the heat more effectively and dispersing the heat towards the surrounding environment by means of special dissipation flaps, thus allowing an adequate thermal equilibrium to be achieved and maintained; said heat sink being constrained to the nozzle.

5. The extrusion system according to claim 4, wherein said extruder comprises an outer straw which holds the small ceramic tube internally for the thread of filler material to flow, while externally the outer straw is constrained to the heat sink; the material of such a straw having high thermal conductivity, to allow and favor the transfer of heat from the small inner tube towards the outer heat sink.

6. The extrusion system according to claim 5, wherein said extruder comprises an extruder connection, which is firmly constrainable to the pressing carriage, which is screwed to the outer straw; wherein said extruder connection has an inner ledge for ensuring the packing of the small ceramic tube against the nozzle, thus avoiding the molten material from exiting from the connection orifices.

7. The extrusion system according to claim 1, wherein said extruder comprises a heating block provided with heating elements, a temperature detection sensor and a block made of Steel, which contains said heating elements and on which the nozzle is fixed, to which the heat produced by said heating elements is transferred by conduction.

8. The extrusion system according to claim 7, wherein such a heating block is externally protected by a layer of insulating material for example, for limiting the heat dissipation outwards thus improving the efficiency of the heating of the block itself; wherein the presence of this insulation is also important for avoiding or reducing the undesired heating of the material just pressed by the extruder.

9. The extrusion system according to claim 8, wherein the shape of the heating block is cylindrical or parallelepiped or polygonal or polyhedral.

10. The extrusion system according to at least claim 7, wherein said extruder comprises a steel cover, which—along with a cover/protective plate—is configured for the connection of the air blowing means and to act as a container for the insulating material; said cover and said plate facilitating and favoring the protection of the just pressed piece or piece being pressed against the high temperatures generated by the heating block.

11. The extrusion system according to claim 1, wherein said blowing means comprise one or more cooling air conveyers, each of which is designed to direct and channel the compressed air flow directly into the outer transversal constriction zone of the nozzle.

12. The extrusion system according to claim 11, wherein—in order to interrupt the transition of heat from the melting zone to the loading zone of the thread of filler material—the cooling air is conveyed into the section straddling the end of the loading zone and the beginning of the zone with small outer transversal dimensions.

13. (canceled)

14. The extrusion system according to claim 3, wherein the geometry of the nozzle, combined with the cooling air flow and the small tube made of alumina, allows the extruder to work at high temperatures, higher than 400° C., ensuring the extrusion of the material, thus avoiding occlusions of the supply channel.

15. The extrusion system according to claim 1, wherein the components of the extruder define, as a whole, a channel or conduit for the thread of filler material to pass, crossing it from the inlet to the outlet.

16. The extrusion system according to claim 6, wherein the proximal part of the nozzle and the distal part of the outer straw, adjacent to each other, are screwed to the heat sink, so that when the connection of the extruder is screwed and tightened to the proximal part of the straw itself, the small tube is axially pressed between the ledge of the straw at one end thereof and the ledge present in the nozzle at the opposite end thereof, thus avoiding potential spillages or leakages of molten material inside the extruder.

17. The extrusion system according to claim 1, wherein the thread of filler material slides directly into thean outer straw and into the nozzle, without further intermediate components.

18. The extrusion system according to claim 1, wherein the body of the nozzle spans the entire extruder and is screwed directly to an upper connection; wherein the thread of filler material slides directly into the connection and into the nozzle without further intermediate components.

19. The extrusion system according to claim 1, wherein the body of the nozzle is configured to be directly removable from the bottom without needing to dismantle any other component of the extruder; for such a purpose, the proximal end of the nozzle is directly fixed to the base of a connection, which also includes a heat sink.

20. The extrusion system according to claim 1, wherein the components of the extruder are all assembled and compacted coaxially with one another, so that the thread of the filler material can pass therein without undesired jamming or deviations: from the inlet in a solid state to the outlet hole of the nozzle, from which the filler material exits in a viscoelastic or fluid state.

21. The extrusion system according to claim 1, wherein the inner conduit of the end part of the nozzle is cylindrical like the previous section of the conduit itself, or the inner conduit is substantially conical, or the inner conduit is provided with at least three different diameters gradually decreasing towards the outlet.

22. The extrusion system according to claim 21, wherein the inner diameters of the end part of the nozzle are thus divided:
diameter 2 mm
diameter 1.2 mm
diameter 0.8 mm
diameter 0.4 mm
wherein the greater diameter receives the filament, which can have a diameter of 1.75 mm, where the melting starts so that the filament slides in the different diameters, while the viscosity thereof decreases and the flow speed increases until exiting from the last smaller diameter.

23. The extrusion system according to claim 21, wherein the inner diameters of the end section of the nozzle have the following reference ranges:
larger diameter equal to 2.5 mm±1
first intermediate diameter 1.2 mm±0.3
second intermediate diameter 0.8 mm±0.35
outlet end diameter 0.4 mm±0.35.

24. The extrusion system according to claim 1, wherein said nozzle is made of stainless steel or tungsten carbide.

25. The extrusion system according to claim 1, wherein the end part of the inner conduit of the nozzle is provided with an insert made of ruby or tungsten carbide, or with an opportune surface treatment.

26. The extrusion system according to claim 1, wherein said blowing means comprise a conveyor for the cooling air, which is intended to direct and channel the compressed air flow directly into the outer transversal constriction zone of the nozzle, wherein a channeling is also comprised, which is configured to channel the cooling air all around said outer transversal constriction zone of the nozzle and let out said air from the side opposite to the conveyor.
